(19) United States
(12) Patent Application Publication
(10) Pub. No.: US 2022/0163948 A1
(43) Pub. Date: May 26, 2022

(54) Method and Apparatus for Automatically Selecting an Optimum Production Cycle

(71) Applicant: Siemens Aktiengesellschaft, Muenchen (DE)

(72) Inventors: Volker FRANZE, Lauf an der Pegnitz (DE); Markus M. GEIPEL, Muenchen (DE); Axel ROTTMANN, Feldkirchen (DE); Kai WEINERT, Altdorf (DE)

(21) Appl. No.: 17/600,255

(22) PCT Filed: Mar. 17, 2020
(86) PCT No.: PCT/EP2020/057185

§ 371 Date: Sep. 30, 2021

(30) Foreign Application Priority Data
Apr. 1, 2019 (EP) 19166537.1

(51) Int. Cl. G05B 19/418

(52) U.S. Cl. CPC G05B 19/41805; G05B 19/41865

(57) ABSTRACT

A device, computer program product and method for automatically selecting an optimum production process for an industrial product, wherein an optimum production variant for producing the industrial product is automatically provided.

### CROSS-REFERENCE TO RELATED APPLICATIONS

This is a U.S. national stage of application No. PCT/EP2020/057185 filed 17 Mar. 2020. Priority is claimed on European Application No. 19166537.1 filed 1 Apr. 2019, the content of which is incorporated herein by reference in its entirety.

### BACKGROUND OF THE INVENTION

### 1. Field of the Invention

The present invention relates to industrial automation systems and, more particularly, to a method and apparatus for automatically selecting an optimum production cycle.

### 2. Description of the Related Art

The basis for market success for an industrial product is an optimum production process. An optimum production process complies with a specific number of desirable performance metrics for the industrial product orderer, such as quality, quantity, and/or costs. In particular, a major consideration in this context is that an industrial product is, in most cases, very complex and made up of various individual components. These individual components and the final production can be provided by various induction product producers at different production sites. The entire production process starting with commissioning, through production to delivery therefore requires intensive prior planning and continual analysis and supervision or correction.

Cross-producer planning of a production process for an industrial product, where the production process is optimum for the industrial product orderer in accordance with its desired performance metrics, is still a process that is usually performed manually when using techniques that are known in the prior art. In particular, it is necessary in the planning phase, for example, to analyze how an industrial product can be appropriately broken down into subcomponents for production. Moreover, it is necessary to analyze how optimum production of the industrial product needs to be performed to comply with the accordingly demanded performance metrics. Furthermore, it is necessary to analyze which producer can perform production with which production capacity and at which production site. In accordance with the above analysis, production of the industrial product or the individual components thereof needs to be distributed over the previously analyzed production sites. In addition, it is necessary to analyze whether the industrial product can be completely farmed out, partially farmed out or completely produced in-house.

These analysis steps are process steps that usually need to be performed manually. Appropriately breaking down the industrial product into subcomponents is a manually configured process and is based on human experience or on the fact that already existing components can be reused. Similarly, the optimum distribution of production over multiple producers/production sites is a manual step. This requires requests to be sent, and for tenders to be examined and compared. Additionally, the difficulty arises that contracts additionally need to be negotiated when involving external producers.

This increases the time involvement and technical complexity for planning an optimum production cycle for an industrial product.

### SUMMARY OF THE INVENTION

It is therefore an object of the present invention to provide a method and apparatus that automatically provide an optimum production cycle for producing an industrial product.

This and other objects and advantages are achieved in accordance with the invention by an apparatus and method and an apparatus for automatically selecting an optimum, where the method comprises an apparatus receiving an industrial product description, provided by an industrial product orderer, and a material parts list for the industrial product, where the material parts list comprises a number of the respective individual components of the industrial product in accordance with the received industrial product description; checking whether a production direction, provided by the industrial product orderer, for producing the industrial product is also received; generating a production direction for producing the industrial product based on the received industrial product description if a production direction for producing the industrial product is not received from the industrial product orderer; breaking down the generated or received production direction for producing the industrial product into at least one production instruction that comprises individual separate production steps and/or subassemblies of the industrial product; transmitting by the apparatus the production instruction to at least one industrial product producer in order to ascertain necessary production conditions for the industrial product in accordance with the transmitted production instruction; receiving by the apparatus the ascertained production conditions of the industrial product producer for producing the industrial product; and establishing by the apparatus the received production conditions as a basis for selecting the optimum production cycle for the industrial product.

Within the context of the present invention, a production cycle should be understood to mean the complete process for producing an industrial product. This starts with the commissioning of production of an industrial product by an industrial product orderer and comprises the core areas of preliminary planning, transport, production, dispatch, delivery of the industrial product produced to the industrial product orderer. The industrial product orderer, such as a purchaser, commissions the apparatus according to the present invention to provide an optimum production cycle for a desired industrial product.

Moreover, within the context of the present invention, an industrial product producer should be understood to mean the entity that has the machines, know-how and capacities available for producing the ordered industrial product and can make the machines, know-how and capacities available for production at the time.

Furthermore, within the context of the present invention, an industrial product description should be understood to mean the specification of the industrial product, such as in digital form, in which the industrial product is specified. By way of example, the industrial product description comprises the dimensions, the color, the functional description and the material from which the industrial product is produced. This illustrative listing is not a restriction for the parameters contained in the industrial product description. On the contrary, other parameters can also be included in the industrial product description. The material parts list describes the number of individual components to be used for producing the industrial product.

Furthermore, within the context of the present invention, a production direction should be understood to mean the direction for producing and assembling the industrial product. This production direction can be broken down into individual production instructions. The production instruction can comprise individual separate production steps and/or subassemblies, and also the production of the industrial product thereby. In this regard, the production of the industrial product is split down to the smallest subcomponent and can therefore be produced by different industrial product producers.

The present invention is based on the knowledge that a need exists for automation of the planning in the production process. Advantageously, the present invention can be used to perform all of the steps required for producing, in particular distributed production of, an industrial product over multiple and different production sites and industrial product manufacturers, which previously had to be performed manually, in an automated manner, in particular in an optimally automated manner.

An additional advantage is that the industrial product, which has not yet been produced previously, can be appropriately broken down quickly, efficiently and in an automated manner into individual production instructions. Here, an industrial product orderer does not itself need to establish this capability for producing its desired industrial product.

Furthermore, the selected optimum production cycle can be used for subsequent production processes for identical or similar industrial products in an identical or analogous manner during production, allowing production time and costs to be reduced.

In one advantageous embodiment, the optimum production cycle for the industrial product comprises an optimum split for the industrial product into the production instruction and over the industrial product producers and mapping of the production instruction to the received production conditions of the industrial product producers.

Advantageously, the production instructions needed for optimum production of the industrial product are mapped to the available industrial product producers having the appropriate production conditions. In particular, this can involve the optimum production condition of an industrial product producer being assigned to a production instruction, as a result of which the production process can be performed in a manner optimized for this production instruction and therefore efficiently in terms of time and costs.

In a further advantageous embodiment, the selection of the optimum production cycle for an industrial product is performed by an artificial neural network trained with the received production conditions.

Advantageously, the production instruction and the production conditions provided by the industrial product producer(s) can be taken as a basis for training an artificial neural network. Based on the trained neural network, the optimum production cycle can be provided more quickly and more efficiently for subsequent and comparable further requests to produce an industrial product. By way of example, it is therefore possible to identify industrial product producers for specific industrial products or subcomponents having appropriate production conditions suitable for an optimum production cycle. Complex analysis of available industrial product producers and the production conditions thereof for the industrial product is possible with lower outlay in terms of time and cost.

The artificial neural network can automatically select optimum production cycles based on the previously received producer conditions and the selection of the production cycles that is accordingly made for the received producer conditions.

In one embodiment, the artificial neural network comprises a deep neural network (DNN), in particular a convolutional neural network (CNN) and/or a recurrent neural network (RNN) and/or a deep feed forward network.

A DNN is an artificial neural network having multiple layers between the input and output layers. The DNN here looks for the correct mathematical manipulation of the data to convert the input into the output. This involves a linear or nonlinear relationship being made. The network moves through the layers and calculates the probability for each output. The aim is for the network to be finally trained to break down data into features, to identify trends in the data that exist over all random samples and to classify new data based on their similarities, without the need for human action.

DNNs can model complex nonlinear relationships. DNN architectures here produce composition models in which the object can be expressed as a layered assembly of primitives. The additional layers of the DNN allow the assembly of features from lower layers, which means that potentially complex data can be modelled with fewer units than in a similarly powerful flat network.

In principle, the structure of a conventional convolutional neural network consists of one or more convolutional layers, followed by a pooling layer. This layer can be repeated as often as desired, in principle; if there are enough repetitions then the term deep convolutional neural networks is used, these falling within the realm of deep learning.

In a further advantageous embodiment, the production conditions comprise a producibility.

Advantageously, it is possible to automatically query whether an industrial product producer can produce the industrial product or individual subcomponents of the industrial product.

In a further advantageous embodiment, the production conditions comprise a sum of the production costs.

Advantageously, it is possible to automatically query which costs are incurred for producing the industrial product or for an individual subcomponent of the industrial product at the respective industrial product producers and the individual production sites.

In a further advantageous embodiment, the production conditions comprise a time of the start of production.

Advantageously, it is possible to automatically query when production for an industrial product can be started. This allows efficient distribution and optimization of the production process for an industrial product having multiple separate individual components that are produced in a distributed manner.

In a further advantageous embodiment, the production conditions comprise a duration of production.

Advantageously, it is possible to automatically query when production for an industrial product can be completed and what the time period for production of the industrial product is. This allows efficient distribution and optimization of the production process for an industrial product having multiple separate individual components that are produced in a distributed manner.

In a further advantageous embodiment, the production conditions comprise a time of product delivery.

Advantageously, it is possible to automatically query when production of the industrial product or a subcomponent of the industrial product is complete. This allows optimization of the production process and optimization of delivery.

In a further advantageous embodiment, the production conditions comprise achievable performance metrics.

A performance metric denotes a metric that can be used to measure and/or ascertain the progress or the degree of achievement with respect to important objectives or critical success factors. Advantageously, it is possible to automatically query which performance metrics the respective industrial producers can achieve. These can be compared with the performance metrics called for by the industrial product orderer. This allows optimized, more efficient and faster selection of appropriately suited industrial product producers for producing the industrial product.

In a further advantageous embodiment, the production conditions comprise achievable quality metrics.

Advantageously, it is possible to automatically provide quality assurance for the industrial product that is to be produced via prior automatic querying of quality metrics. More advantageously, ongoing production processes can be inspected for their demanded quality via further queries.

In a further advantageous embodiment, the ascertainment of the production conditions comprises a simulation for the production of the industrial product, in particular a 2D/3D CAD model, by the industrial product producer.

Advantageously, the industrial product producer can provide a simulation of the industrial product that is to be produced and/or of the production process to the industrial product producer at the outset. This allows more efficient and faster selection of the optimum production cycle.

Preferably, the industrial product producer can make a 2D/3D CAD model of the industrial product that is to be produced available to the industrial product producer. This allows more optimum and faster selection of the optimum production cycle, since the industrial product orderer can evaluate the result of production already and make possible modifications prior to the actual production. Necessary modifications after the start of production, resulting in additional temporal and/or monetary costs, are avoided.

In a further advantageous embodiment, the ascertainment of the production conditions comprises production of a prototype of the industrial product by the industrial product producer.

Advantageously, the industrial product orderer can inspect the ordered industrial product by means of a prototype prior to actual approval of the production cycle. It is therefore possible for the selection of the optimum production cycle to be optimized further.

In a further advantageous embodiment, the optimum production cycle is provided to the industrial product orderer as a digital document.

Advantageously, at least one, preferably, in accordance with the performance metrics called for by the industrial product orderer, a multiplicity of, optimum production cycle(s) can be made available to the industrial product orderer in a digital document. Based on the available optimum production cycles, the industrial product orderer can approve the optimum production cycle for the industrial product and initialize production of the industrial product.

The digital document can comprise a portable document format (PDF), a JavaScript Object Notation (JSON) format, a Word format, a SubRip text format, a text format and/or an EBU-STL format. The optimum production cycle can therefore be provided to the industrial product orderer in editable and uneditable digital documents for the purpose of selection and approval of the optimum production cycle.

In a further advantageous embodiment, the optimum production cycle is provided to the industrial product orderer via a web interface.

Advantageously, the industrial product producer can therefore analyze the selected optimum production cycle(s) and approve or commission it/them for production of the industrial product regardless of the production site, on a portable device (e.g., tablet, laptop, or smartphone) or a computer, such as via a web browser. Moreover, the industrial product producer can be provided with appropriate simulations of the industrial product via the web interface for the purpose of verification.

It is also an object of the invention to provide an apparatus for automatically selecting an optimum production cycle for an industrial product, where the apparatus comprises a receiving unit configured to receive an industrial product description, provided by an industrial product orderer, and a material parts list for the industrial product, where the material parts list comprises a number of the respective individual components of the industrial product in accordance with the received industrial product description, and configured to receive at least one production condition of an industrial product producer for producing the industrial product; a checking unit configured to check whether a production direction for producing the industrial product is also received; a generating unit configured to generate a production direction for producing the industrial product on the basis of the received industrial product description if a production direction for producing the industrial product is not received from the industrial product orderer;
a breakdown unit configured to break down the generated or received production direction for producing the industrial product into at least one production instruction that comprises individual separate production steps and/or subassemblies of the industrial product; a transmitting unit configured to transmit the production instruction to at least one industrial product producer in order to ascertain necessary production conditions in accordance with the transmitted production instruction for producing the industrial product; and a selection unit configured to establish the production conditions received by the receiving unit as a basis for selecting the optimum production cycle for the industrial product.

In one advantageous embodiment of the apparatus, the optimum production cycle for the industrial product comprises an optimum split for the industrial product into the production instruction and over the industrial product producers and mapping of the production instruction to the received production conditions of the industrial product producers.

In a further advantageous embodiment of the apparatus, the selection of the optimum production cycle for an industrial product is performed by an artificial neural network trained with the received production conditions.

In a further advantageous embodiment of the apparatus, the apparatus communicates with the industrial product orderer and/or the industrial product producer via a protected communication connection that comprises wired or wireless communication.

Advantageously, the apparatus can communicate with the industrial product producers and the industrial product orderer via a network, such as the Internet, via a wired communication connection (USB, Ethernet, ISDN) or wireless communication connection (Bluetooth, WLAN). The communication connection can be made via a protected or encrypted communication connection, such as HTTPS, with encryption of the data by SSL/TSL. Furthermore, certificates for signing data can be used for improved protection of the communication and of the data interchange.

In a further advantageous embodiment of the apparatus, the apparatus comprises a display element, in particular a touch display, for displaying the optimum production cycle.

Advantageously, the apparatus can comprise a display element for showing the production cycle. The display element may be positioned separately from the apparatus for displaying the optimum production cycle. In one embodiment, a display element of another device that communicates with the apparatus can be used. Moreover, the display element can be used to show the selection process. In this regard, the industrial product orderer can select an optimum production cycle during the selection process or can terminate the selection process early.

In a further advantageous embodiment of the apparatus, the optimum production cycle is provided to the industrial product orderer as a digital document.

In a further advantageous embodiment of the apparatus, the optimum production cycle is provided to the industrial product orderer via a web interface.

In a further advantageous embodiment of the apparatus, the apparatus is in the form of a computer, a portable device, in the form of a server and/or server network, in particular in the form of a cloud system.

It is also an object of the invention to provide a computer program containing program code for performing the method in accordance with disclosed embodiments when the computer program is executed on an electronic device. The computer program can be provided as a signal by download or can be stored in a storage unit of a portable apparatus containing computer-readable program code in order to cause an apparatus to execute instructions in accordance with disclosed embodiments of the method. Realizing the invention via a computer program product has the advantage that already available electronic devices, such as computers, portable devices or smartphones, can easily be used via software updates in order to perform automatic selection of an optimum production cycle for an industrial product, in accordance with disclosed embodiments of the invention.

The above configurations and developments can, insofar as is practical, be combined with one another in any desired manner. Further possible configurations, developments and implementations of the invention also encompass not explicitly mentioned combinations of features of the invention described above or below with respect to the exemplary embodiments. In particular, a person skilled in the art will also add individual aspects as improvements or supplementations to the respective basic form of the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in more detail below on the basis of the exemplary embodiments indicated in the schematic figures of the drawings, in which:

FIG. 1 shows a schematic block diagram of an exemplary embodiment of automatic selection of an optimum production cycle for an industrial product in accordance with the invention;

FIG. 2 shows an exemplary flowchart for of an exemplary embodiment of a method in accordance with the invention;

FIG. 3 shows a schematic block diagram of an exemplary embodiment of an apparatus in accordance with the invention;

FIG. 4 shows a schematic block diagram of a timing sequence for a method in accordance with the invention.

### DETAILED DESCRIPTION OF THE EXEMPLARY EMBODIMENTS

The accompanying drawings are intended to convey further understanding of the embodiments of the invention. They illustrate embodiments and are used in conjunction with the description to explain principles and concepts of the invention. Other embodiments and many of the cited advantages will emerge in the light of the drawings. The elements of the drawings are not necessarily shown to scale in relation to one another.

In the figures of the drawing, identical, functionally identical and identically acting elements, features and components will each be provided with the same reference signs—unless explained otherwise.

FIG. 1 shows a schematic block diagram of an exemplary embodiment for automatic selection of an optimum production cycle for an industrial product.

In FIG. 1, reference sign 10 denotes the apparatus for automatically selecting an optimum production cycle 50. The apparatus 10 uses a protected communication connection 18 to communicate with the industrial product orderer 20 and the industrial product producer 30 via a network 40, such as the Internet. The industrial product orderer 20 uses a protected connection 18 to make an industrial product description 21 and a material parts list 22 for producing an industrial product available to the apparatus 10. The industrial product description 21 can, for example, be in the form of a text and declare features and/or properties of the industrial product. In particular, the industrial product description can be in the form of a digital twin of the industrial product.

The apparatus 10 establishes the industrial product description 21 provided by the industrial product orderer as a basis for generating a production direction 23, if the production direction is not additionally provided by the industrial product orderer 20. The production direction 23 for the industrial product specifies the individual subassemblies of the industrial product and the individual production steps required to produce the industrial product. The apparatus 10 breaks down the generated or received production direction 23 into at least one production instruction 19, which is provided to at least one, preferably multiple, industrial product producer(s) 30, with different production sites, via a protected communication connection 18. This has the advantage that a complex industrial product is mapped to individual and less complex and sophisticated substeps and therefore the production cycle can be optimized via distributed production.

Based on the received production instruction, the industrial product producers provide production conditions 31 for producing the industrial product to the apparatus 10 via the protected communication connection. The production conditions comprise, for example, a producibility of the industrial product. As a result, the industrial product producer credibly confirms whether production of the industrial product or a subcomponent of the industrial product can be performed. Moreover, the production conditions 30 comprise, for example, the sum of the production costs, the time of the start of production, the duration of production, the time of product delivery, achievable performance metrics and/or achievable quality metrics.

The apparatus 10 receives the production conditions 31 and establishes the received production conditions 31 as a basis for selecting an optimum production cycle 50 for producing the industrial product. Preferably, the provided optimum production cycle 50 comprises a multiplicity of optimum production cycles that have been appropriately selected according to performance metrics provided by the industrial product orderer 20. The industrial product orderer 20 can select from the multiplicity of optimum production cycles 50 the one that is most consistent with the demand on time, costs and/or efficiency.

In one embodiment, the optimum production cycle 50 is provided as a digital document via the protected communication connection 18.

In a further embodiment, the optimum production cycle is made available to the industrial product orderer via a web interface.

In a further embodiment, the apparatus 10 can provide a data interchange, such as a digital document, between the apparatus 10 and the industrial product orderer 30 and the apparatus 10 and the industrial product producer 30. Preferably, the digital document can include a secrecy agreement and/or contractual conditions for producing the industrial product that are confirmed by a digital signature.

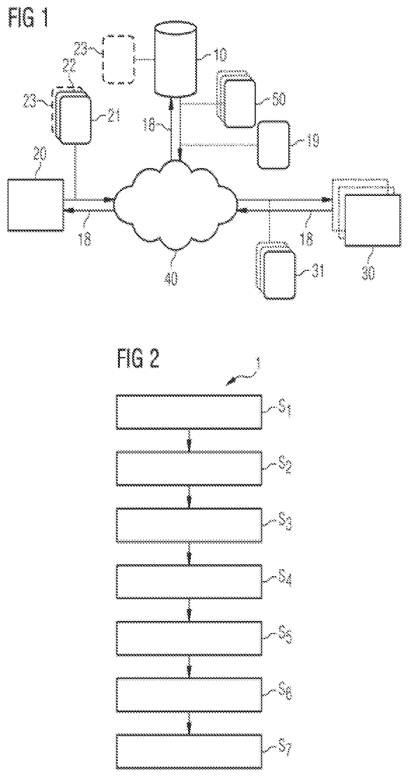

FIG. 2 shows an exemplary flowchart of an embodiment of a method 1 in accordance with the invention.

In the exemplary illustrated embodiment, the method 1 comprises multiple steps. In a first step S1, an apparatus 10 receives an industrial product description 21, provided by an industrial product orderer 20, and a material parts list 22 for the industrial product. The material parts list 21 comprises a number of the respective individual components of the industrial product in accordance with the received industrial product description 21.

In a second step S2, a check is performed to establish whether a production direction 23, provided by the industrial product orderer 20, for producing the industrial product is also received.

In a third step S3, a production direction 23 for producing the industrial product is generated based on the received industrial product description 21 if a production direction 23 for producing the industrial product is not received from the industrial product orderer 20.

In a further step S4, the generated or received production direction 23 for producing the industrial product is broken down into at least one production instruction 19. The individual production instruction 19 comprises individual separate production steps and/or subassemblies of the industrial product. The production of the industrial product can be split in this regard, for example, into the production of a printed circuit board, production of the housing, population of the printed circuit board, assembly of the printed circuit board and the housing. A multiplicity of production instructions can be generated in step S4 that are all a way of producing the industrial product.

In a further step S5, the production instruction 19 is transmitted to at least one industrial product producer 30 to ascertain necessary production conditions 31 for the industrial product in accordance with the transmitted production instruction 19. The transmittal of the production instruction 19 is a query to the industrial product producer concerning whether, for example, the production site thereof can produce the industrial product or a subcomponent of the industrial product in an appropriate time, using appropriate materials and with appropriate quality and costs.

In a further step S6, the apparatus 10 receives the ascertained production conditions 31 of the industrial product producer 30 for producing the industrial product. Each industrial product producer 30 and each production site of the industrial product producer 30 ascertains whether the desired production instruction 19, in particular the subassembly and the work step, can be produced and performed. Moreover, each industrial product producer 30 ascertains the conditions under which the subassembly can be provided and the work step can be performed. This ascertained information is provided to the apparatus 10 as production conditions 31.

In a seventh step S7, the received production conditions 31 are established as a basis for selecting an optimum production cycle 50 for the industrial product. Preferably, an optimum production cycle, which comprises an optimum split for the industrial product into subassemblies and production steps and a possible sequence of production sites and industrial product producers, can be selected from all of the provided production conditions 31, in particular all tenders from the industrial product producers and production sites for producing the industrial product. The optimum production cycle can be provided to the industrial product orderer 20 to approve the production of the industrial product in accordance with the optimum production cycle.

In one embodiment, the provided production conditions 23 can be used to automatically train an artificial neural network. In particular, the artificial neural network can be trained based on the production conditions 23 and the accordingly manually selected production cycle(s) 50.

In one embodiment, the trained artificial neural network can be used to select an optimum production cycle.

In an alternative embodiment, multiple optimum production cycles are provided and listed according to performance metrics predefined by the industrial product producer 20. The industrial product orderer 20 selects the independently optimum production cycle and can approve or commission the production of the industrial product to the apparatus 10. The apparatus can establish the approved production cycle as a basis for arranging and initializing production of the industrial product with the respective industrial product producers and the production sites.

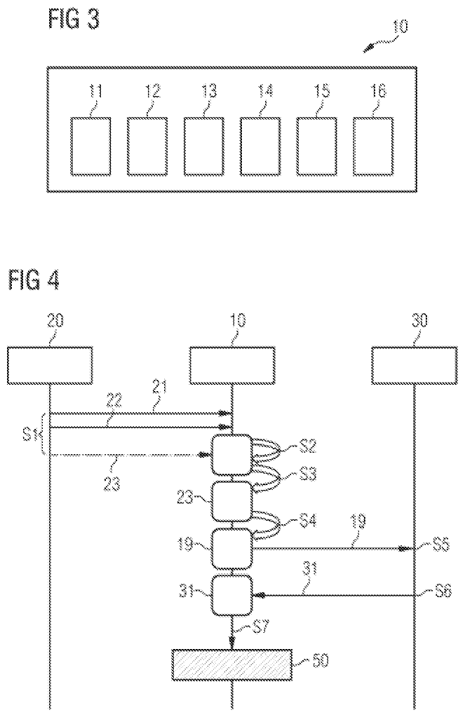

FIG. 3 shows an exemplary schematic block diagram of an embodiment of an apparatus in accordance with the invention. By way of illustration, the apparatus is shown for the automatically selecting an optimum production cycle for a chair, but is not restricted thereto.

In FIG. 3, reference sign 10 denotes an apparatus for automatically selecting an optimum production cycle 50 for producing a chair. The apparatus 10 comprises a receiving unit 11 configured to receive an industrial product description 21 provided by an industrial product orderer 20, such as the construction and design plan for the chair. Furthermore, the apparatus 10 is configured to receive a material parts list 22 for the chair. The material parts list 22 comprises a number of the respective individual components of the industrial product in accordance with the received industrial product description 21, such as the required chair elements, screws, glue and material to be used. Furthermore, the apparatus 10 is configured to receive at least one production condition 31 of an industrial product producer 30 for producing the industrial product.

Additionally, the apparatus comprises a checking unit 12 configured to check whether a production direction 23 for producing the chair is also received.

Moreover, the apparatus comprises a generating unit 13 configured to generate a production direction 23 for producing the chair based on the received industrial product description 21 if a production direction 23 for producing the chair is not received from the industrial product orderer 20. The production direction 23 comprises the description of how the chair is designed and how it should be produced.

Furthermore, the apparatus 10 comprises a breakdown unit 14 configured to break down the generated or received production direction 23 for producing the chair into at least one production instruction 19. The production instruction 19 comprises individual separate production steps and/or subassemblies of the chair. A detailed overview of the individual subassemblies and elements of the chair is therefore provided. Moreover, the respective production steps are recognizable, which allows distributed production by different chair producers, at different production sites.

Moreover, the apparatus 10 comprises a transmitting unit 15 configured to transmit the production instruction 19 to at least one industrial product producer 30 in order to ascertain necessary production conditions 31 in accordance with the transmitted production instruction 19 for producing the chair. Advantageously, an industrial product producer 30 can take/establish the broken-down and hence detailed production instructions as a basis for ascertaining the production conditions for producing the chair or a chair component. In particular, whether the industrial product producer 30 has the appropriate capacity for production, the appropriate methods and the necessary know-how for producing the chair in accordance with the production instruction and to meet demands on quality, costs, material, time and quantity.

In one embodiment, the apparatus 10 comprises a storage unit for storing and/or buffer-storing the production conditions and/or a selected optimum production cycle. The storage unit comprises, for example, a hard disk (HDD), a random access memory (RAM), a flash memory and/or an external storage apparatus connected to the apparatus 10.

Furthermore, the apparatus 10 comprises a selection unit 16 configured to establish the production conditions 31 received by the receiving unit 11 as a basis for selecting the optimum production cycle 50 for the industrial product.

The selected optimum production cycle 50 can be provided to the industrial product orderer 20 on a display unit 17 (not depicted), in particular a touch display.

In one embodiment, the selected optimum production cycle 50 can be provided to the industrial product orderer 20 by a digital document.

In one embodiment, the selected optimum production cycle 50 can be provided to the industrial product orderer 20 by a web interface.

FIG. 4 shows a schematic block diagram illustrating a timing sequence for a method in accordance with the invention.

In a first step S1, an apparatus 10 receives an industrial product description 21, provided by an industrial product orderer 20, and a material parts list 22 for the industrial product. The material parts list 22 comprises a number of the respective individual components of the industrial product in accordance with the received industrial product description 21. In a further step S2, a check is performed to establish whether a production direction 23, provided by the industrial product orderer 20, for producing the industrial product is also received. In a further step S3, a production direction 23 for producing the industrial product is generated based on the received industrial product description 21 if a production direction 23 for producing the industrial product is not received from the industrial product orderer 20. In a further step S4, the generated or received production direction 23 for producing the industrial product is broken down into at least one production instruction 19. The production instruction 19 can comprise individual separate production steps and/or subassemblies of the industrial product. In a further step S5, the production instruction 19 is transmitted by the apparatus 10 to at least one industrial product producer 30 to ascertain necessary production conditions 31 for the industrial product in accordance with the transmitted production instruction 19. In a further step S6, the apparatus 10 receives the ascertained production conditions 31 of the industrial product producer 30 for producing the industrial product. In a further step S7, the apparatus 10 establishes the received production conditions 31 as a basis for selecting the optimum production cycle 50 for the industrial product.

In summary, the disclosed embodiments of the present invention relate to a method for automatically selecting an optimum production cycle for an industrial product, comprising an apparatus receiving an industrial product description, provided by an industrial product orderer, and a material parts list for the industrial product, the material parts list comprising a number of the respective individual components of the industrial product in accordance with the received industrial product description; checking whether a production direction, provided by the industrial product orderer, for producing the industrial product is also received; generating a production direction for producing the industrial product based on the received industrial product description if a production direction for producing the industrial product is not received from the industrial product orderer; breaking down the generated or received production direction for producing the industrial product into at least one production instruction that comprises individual separate production steps and/or subassemblies of the industrial product; transmitting by the apparatus the production instruction to at least one industrial product producer to ascertain necessary production conditions for the industrial product in accordance with the transmitted production instruction; receiving by the apparatus the ascertained production conditions of the industrial product producer for producing the industrial product; and establishing by the apparatus the received production conditions as a basis for selecting the optimum production cycle for the industrial product.

Moreover, the disclosed embodiments of the present invention relate to an apparatus and a computer program product.

In this regard, an optimum production variant for producing the industrial product is provided automatically.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A computer-implemented method for automatically selecting an optimum production cycle for an industrial product, the method comprising:
receiving, by an apparatus, an industrial product description, provided by an industrial product orderer, and a material parts list for the industrial product, the material parts list comprising a number of respective individual components of the industrial product in accordance with the received industrial product description;
checking to determine whether a production direction, provided by the industrial product orderer, for producing the industrial product is also received;
generating a production direction for producing the industrial product based on the received industrial product description if a production direction for producing the industrial product is not received from the industrial product orderer;
breaking down the generated or received production direction for producing the industrial product into at least one production instruction that comprises at least one of individual separate production steps and subassemblies of the industrial product;
transmitting, by the apparatus, the production instruction to at least one industrial product producer to ascertain necessary production conditions for the industrial product in accordance with the transmitted production instruction;
receiving, by the apparatus, the ascertained production conditions of the industrial product producer for producing the industrial product;
establishing, by the apparatus, the received production conditions as a basis for selecting an optimum production cycle for the industrial product;
wherein said selecting of the optimum production cycle for an industrial product is performed by an artificial neural network trained with the received production conditions.

15. The computer-implemented method as claimed in claim 14, wherein the optimum production cycle for the industrial product comprises an optimum split for the industrial product into the production instruction and over the industrial product producers and mapping of the production instruction to the received production conditions of the industrial product producers.

16. The computer-implemented method as claimed in claim 14, wherein the production conditions comprise at least one of (i) a producibility, (ii) a sum of the production costs, (iii) a time of the start of production, (iv) a duration of production, (v) a time of product delivery, (vi) achievable performance metrics and (vii) achievable quality metrics.

17. The computer-implemented method as claimed in claim 14, wherein the production conditions comprise at least one of (i) a producibility, (ii) a sum of the production costs, (iii) a time of the start of production, (iv) a duration of production, (v) a time of product delivery, (vi) achievable performance metrics and (vii) achievable quality metrics.

18. The computer-implemented method as claimed in claim 14, wherein ascertainment of the production conditions comprises a simulation for the production of the industrial product by the industrial product producer.

19. The computer-implemented method as claimed in claim 14, wherein the simulation for the production of the industrial product comprises a 2D/3D CAD model.

20. The computer-implemented method as claimed in claim 14, wherein ascertainment of the production conditions comprises production of a prototype of the industrial product by the industrial product producer.

21. The computer-implemented method as claimed in claim 14, wherein the optimum production cycle is provided to the industrial product orderer as a digital document.

22. The computer-implemented method as claimed in claim 14, wherein the optimum production cycle is provided to the industrial product orderer via a web interface.

23. An apparatus for automatically selecting an optimum production cycle for an industrial product, comprising:
a receiving unit configured to receive an industrial product description, provided by an industrial product orderer, and a material parts list for the industrial product, the material parts list comprising a number of respective individual components of the industrial product in accordance with the received industrial product description, and configured to receive at least one production condition of an industrial product producer for producing the industrial product;
a checking unit configured to check whether a production direction for producing the industrial product is also received;
a generating unit configured to generate a production direction for producing the industrial product based on the received industrial product description if a production direction for producing the industrial product is not received from the industrial product orderer;
a breakdown unit configured to break down the generated or received production direction for producing the industrial product into at least one production instruction which comprises at least one of (i) individual separate production steps and (ii) subassemblies of the industrial product;
a transmitting unit configured to transmit the production instruction to at least one industrial product producer to ascertain necessary production conditions in accordance with the transmitted production instruction for producing the industrial product; and
a selection unit configured to establish the production conditions received by the receiving unit as a basis for selecting the optimum production cycle for the industrial product, wherein the selecting of the optimum production cycle for an industrial product is performed by an artificial neural network trained with the received production conditions.

24. The apparatus as claimed in claim 23, wherein the optimum production cycle for the industrial product comprises an optimum split for the industrial product into the production instruction and over the industrial product producers and mapping of the production instruction to the received production conditions of the industrial product producers.

25. The apparatus as claimed in claim 23, wherein the apparatus comprises a display element, in particular a touch display, for displaying the optimum production cycle.

26. The apparatus as claimed in claim 23, wherein the display element is a touch display.

27. The apparatus as claimed in claim 24, wherein the apparatus comprises a display element, in particular a touch display, for displaying the optimum production cycle.

28. The apparatus as claimed in claim 27, wherein the display element is a touch display.

29. The apparatus as claimed in claim 23, wherein the apparatus communicates with at least one of (i) the industrial product orderer and (ii) the industrial product producer via a protected communication connection which comprises wired or wireless communication.

30. The apparatus as claimed in claim 24, wherein the apparatus communicates with at least one of (i) the industrial product orderer and (ii) the industrial product producer via a protected communication connection which comprises wired or wireless communication.

31. The apparatus as claimed in claim 25, wherein the apparatus communicates with at least one of (i) the industrial product orderer and (ii) the industrial product producer via a protected communication connection which comprises wired or wireless communication.

32. The apparatus as claimed in claim 23, wherein the optimum production cycle is provided to the industrial product orderer via a web interface.

33. The apparatus as claimed in claim 24, wherein the optimum production cycle is provided to the industrial product orderer via a web interface.

34. The apparatus as claimed in claim 25, wherein the optimum production cycle is provided to the industrial product orderer via a web interface.

35. The apparatus as claimed in claim 29, wherein the optimum production cycle is provided to the industrial product orderer via a web interface.

36. A computer program containing program code for performing the method as claimed in claim 14 when the computer program is executed on an electronic device.
